(19) United States
(12) Patent Application Publication
(10) Pub. No.: US 2005/0021659 A1
(43) Pub. Date: Jan. 27, 2005

(54) Data processing system and method

(76) Inventors: Maurizio Pilu, Bristol (GB); David Mark Frohlich, Bristol (GB)

Correspondence Address: HEWLETT-PACKARD COMPANY;Intellectual Property Administration, P.O. Box 272400, Fort Collins, CO, 80527-2400, US

(21) Appl. No.: 10/868,368

(22) Filed: Jun. 15, 2004

(30) Foreign Application Priority Data
Jul. 9, 2003 (GB) 0316028.0

(51) Int. Cl. G06F 15/167

(52) U.S. Cl. 709/213

(57) ABSTRACT

An embodiment relates to sharing digital data. Briefly described, one exemplary embodiment comprises receiving, at an addressee system, data associated with digital data rendered by an addressor system; searching, via the addressee system, for related digital data using the received data; enabling user selection of at least one of the related digital data located by the searching; and outputting the selected related digital data to the addressor system.

### FIELD OF THE INVENTION

Embodiments relate to data processing and, more particularly, to a system and method for sharing digital data.

### BACKGROUND TO THE INVENTION

It has been noted in, for example, Sacks H. (1970) “first” and “second” stories: Topical coherence: Storing and recording experiences, In G. Jefferson (Ed) Lectures on conversation, Volume II. Harvey Sacks (PP249-260). Oxford: Blackwell (incorporated by reference herein) that listeners within a conversation often offer second stories that are recognisably related to a first story being relayed by a first speaker. Typically, the second story is produced in which the listener is a character in a similar position to the speaker's character in the first story. For example, if the first speaker was recounting an amusing anecdote of a skiing trip, the second speaker may also have had an amusing experience on a skiing trip and offer their experience in reply, which has the effect of maintaining or fuelling the conversation. Such second story-telling behaviour demonstrates attention and empathy with the first story-teller and actively engages the listener in the story-telling activity. Sacks further discloses that the inclination to respond to a story by recounting one's own experiences is so strong that people have to be trained not to do it in, for example, counselling sessions undertaken by a psychotherapist.

However, it has been observed that the urge to recount second stories is inhibited in conversations involving photographs. When the first story-teller uses a set of photographs to illustrate a story they are often able to proceed to tell further stories without interruption from their audience. The photographs appear to act as an inhibitor of reciprocal stories and lead to an asymmetrical conversation in which the audience is usually passive. Current digital photo-album technology appears to exacerbate this situation by turning the album into a slide show and increasing the power and control of the speaker over the photographs and conversation. In effect, digital technology may have the effect of suppressing conversation rather than stimulating the urge to engage in conversation.

### SUMMARY OF INVENTION

One exemplary embodiment for sharing digital data comprises receiving, at an addressee system, data associated with digital data rendered by an addressor system; searching, via the addressee system, for related digital data using the received data; enabling user selection of at least one of the related digital data located by the searching; and outputting the selected related digital data to the addressor system.

### BRIEF DESCRIPTION OF THE DRAWINGS

Embodiments of the present invention will now be described, by way of example only, with reference to the accompanying drawings in which:

FIG. 1 shows a communication system;

FIG. 2 illustrates, schematically, the operation of embodiments of the present invention;

FIG. 3 illustrates a flow chart of a process performed by embodiments of the present invention;

FIG. 4 illustrates the operation of the second embodiment;

FIG. 5 depicts a flow chart of a process performed by a second embodiment of the present invention;

FIG. 6 depicts a flow chart of a process performed by another embodiment of the present invention; and

FIG. 7 depicts a flow chart of a process performed by yet another embodiment of the present invention.

### DETAILED DESCRIPTION

Various embodiments actively stimulate a listener into recounting memories related to a story they are being told, which then affords them the opportunity to engage the story-teller with a tale of their own. It will be appreciated that related media comprises media having at least something in common with the original media rendered at the addressor system, that is, the media share a common theme or context. As used herein, “rendered” refers to the process of displaying an image on a display, wherein the image corresponds to digital data.

Within a sharing or collaborative environment, one may wish to show the located media to a friend or colleague. Suitably, some embodiments provide a method wherein the data associated with the selected digital data comprises a copy of the selected digital data and method further comprises rendering the copy of the selected digital data at the addressor or addressee computer system. Within the current specification, the term “sharing” comprises an exchange of ideas or information and includes the showing of media and the exchange of media.

Once media of potential interest has been identified, the user may select one for display to a friend or transmission to their friend's computer or other display device. Suitably, embodiments provide a method further comprising enabling selection of the rendered at least digital data and transmitting data associated with the selected digital data to the addressor computer system.

Embodiments are provided in which the data associated with the selected digital data comprises at least one of a copy of the selected digital data and metadata describing the selected digital data.

Embodiments may provide a method in which the data associated with the selected digital data comprises the copy of the selected digital data and the metadata.

Some alternative embodiments provide a method in which the data associated with the selected digital data comprises only the metadata.

Also, embodiments provide a method in which the received data comprises a copy of the digital data of the addressor computer system and the method further comprises rendering the received data to produce a rendered copy of the digital data associated with the addressor computer system.

Another embodiment provides a communication system comprising first and second computers to exchange, via a communication network, data comprising at least one of media of the first computer and metadata associated with the media of the first computer; the second computer comprising a context-based search-engine to search for and identify media accessible by the second computer having a context associated with or derived from said at least one of media of the first computer or the metadata associated with the first computer.

A further embodiment provides a computer program element for implementing embodiments as described in this specification. The term “computer program element” comprises at least a part or the whole of a computer program. Furthermore, embodiments provide a computer program product comprising a computer readable storage medium storing such a computer program element.

A yet another embodiment provides a method of sharing media between first and second computer systems, the method comprising: rendering media at the first computer;
transmitting data associated with the media rendered at the first computer to the second computer; receiving the transmitted data at the second computer; searching, using the received data, at the second computer, to identify media having a context associated with the media rendered at the first computer; displaying at least one media of any identified media; selecting, at the second computer, the at least one media of any identified media; transmitting data associated with the selected media to the first computer; receiving the transmitted data associated with the selected media; and processing the received data associated with the selected media.

Other embodiments may provide a method of sharing digitally produced audio or visual data comprising outputting, at a first computer, a digital photograph for showing to a third party by a first party; transmitting, from the first computer to a second computer, the digital photograph and associated metadata; receiving the transmitted digital photograph at the second computer; searching, using the received metadata, to identify a further digital photograph, accessible by the second computer, having a respective metadata associated the received metadata; and outputting, at the second computer, the further digital photograph to stimulate a conversation between the first and third parties using their respective digital photographs.

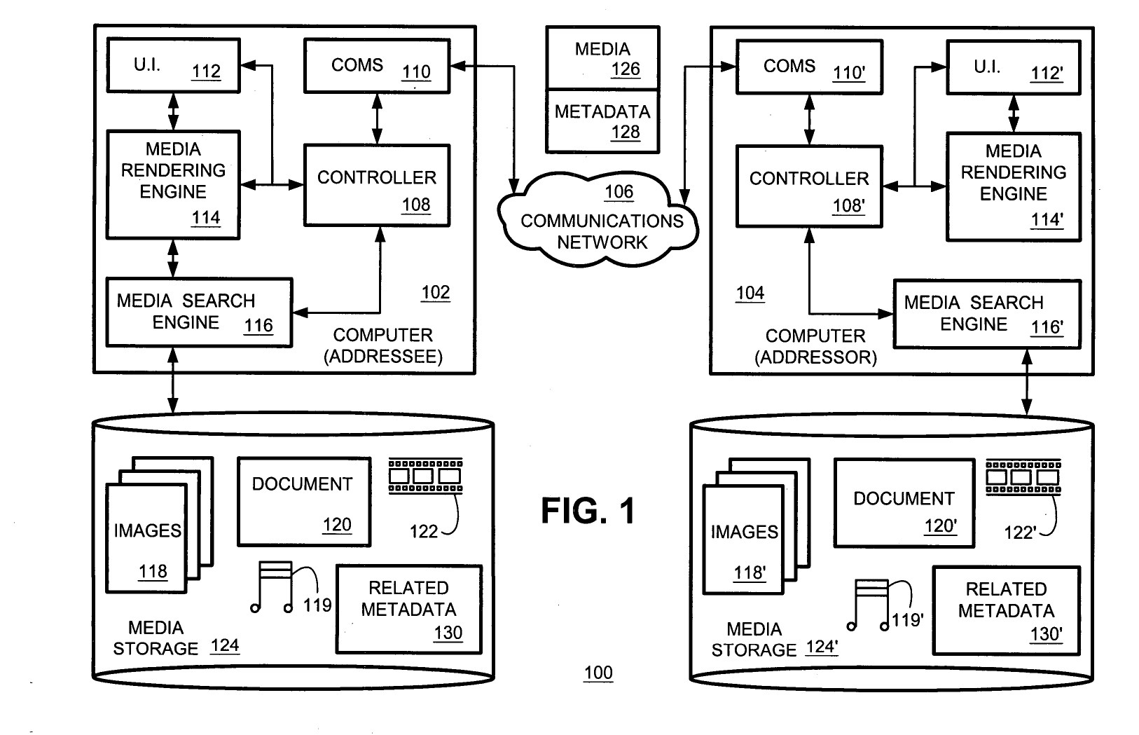

FIG. 1 shows a communication system 100 comprising two processing systems, referred to as computer 102 (addressee system) and computer 104 (addressor system). The computers 102 and 104 (may be any type of processing systems such as, for example, a desktop PC, a mobile computer, palm computer or a personal digital assistant, lap top or other consumer device or appliance configured for processing. Furthermore, the computers 102 and/or 104 may be mobile communication devices such as, for example, mobile telephones or other communication devices. Such mobile telephones are capable of picture messaging. The computers can communicate via a communication network 106. The communication network 106 may be, for example, the Internet, a wired network or a wireless network. The term network encompasses a single link between two nodes, that is, it encompasses a single communication channel between the two computers 102 and 104. The link may span various types of communication systems.

The computers 102 and 104 comprise respective controllers 108 and 108′ for controlling the operation of the computers 102 and 104 and managing the interaction of various elements of computers 102 and 104. The computers 102 and 104 communicate, under the control of respective controllers 108 and 108′, using respective communication mechanisms 110 and 110′. The communication may be wired or wireless according to the type of communication network 106 relied upon by the computers 102 and 104. For example, the computers 102 and 104 may communicate using GSM, CDMA, IEEE 802.11b, Bluetooth, TCP/IP, WAP, HTTP or some other communication protocol.

The communication mechanisms 110 and 110′ are arranged to handle all necessary signalling and data exchange to allow the computers 102 and 104 to exchange information. Each computer presents a user interface (UI) 112 and 112′, respectively, via which users (not shown) can interact with the computers 112 and 104. Typically, the user interfaces 112 and 112′ comprise a display for displaying digital data such as, for example, text and graphical information, a user input device such as, for example, a keyboard, keypad or mouse, and, an audio output device such as, for example, audio speakers. The input devices constituting the user interfaces 112 and 112′ may depend upon the nature of the media to be output to the users (not shown) and the capabilities of the devices. Alternative embodiments of the present invention might also include other output devices such as, for example, printers or the like for producing printed media.

Computer system 102 and 104 may comprise at least one media rendering engine 114 and 114′. The media rendering engines 114 and 114′ are arranged to display or output media to users (not shown). Within the context of described embodiments, the term “media” comprises digital data representing at least one of audio, visual information, and/or digital data from which such audio or visual information can be derived. In particular, the term “media” comprises, but is not limited to, digitally produced still or video image data, with or without associated digital audio, such as, for example, digital photographs, digital video, and other types of digital data. An example of such a media rendering engine may be Windows Media Player available from Microsoft Corporation in the event that the media to be rendered is audio visual data or, for example, Internet Explorer in the event that the media to be rendered is an image file such as, for example, a JPEG file. Therefore, it will be appreciated that the terms “render,” “rendered” and “rendering” comprise producing a human perceivable output from the media, that is, from the digital data. Furthermore, the media rendering engine may be a word processor such as, for example, Word, also available from Microsoft Corporation, in the event that the media is a text or written word document. It will be appreciated that the computer systems 102 and 104 may comprise a number of media rendering engines according to the types of media computer systems 102 and 104 may be expected to handle.

Each computer system 102 and 104 is provided with a media search engine 116 and 116′, respectively, implemented, at least in part, using software. Realisations of embodiments of a media search engine might, for example, comprises a searchable data base for storing the media and a data base program for accessing the searchable data base to retrieve the media. The media search engines 116 and 116′ are used to identify media such as, for example, images 118 and 118′, audio files 119 and 119′, documents 120 and 120′ and video 122 and 122′, stored using respective non-volatile media storage 124 and 124′. The non-volatile storage may take the form of any convenient non-volatile storage such as, for example, flash memory or, in the illustrated embodiments 130 and 130′, as hard disk drives (HDDs). It can be appreciated that each system 102 and 104 has access to at least some distinct, that is, separate, media. Although embodiments of the present invention have been described with reference to flash and HDD type storage, embodiments can use other forms of storage.

Media stored using the non-volatile storage 124 and 124′ has associated metadata that is related to each media item to assist the media search engines 116 and 116′ in identifying media of interest. For example, the media may be a JPEG image of a number of cows standing by a lake and the associated metadata may comprise the set of words “cow” and “lake.” It can be appreciated that media can be related or categorised using the metadata. For example, a pair of pictures comprising respective images of cows might both have the word “cow” as part of their respective metadata. Such pictures are considered to be related as they both concern or depict similar, or the, same subject-matter. That is, the pictures, or at least their associated metadata, have something in common, that is, a substantially similar context. The same also applies to other forms of media.

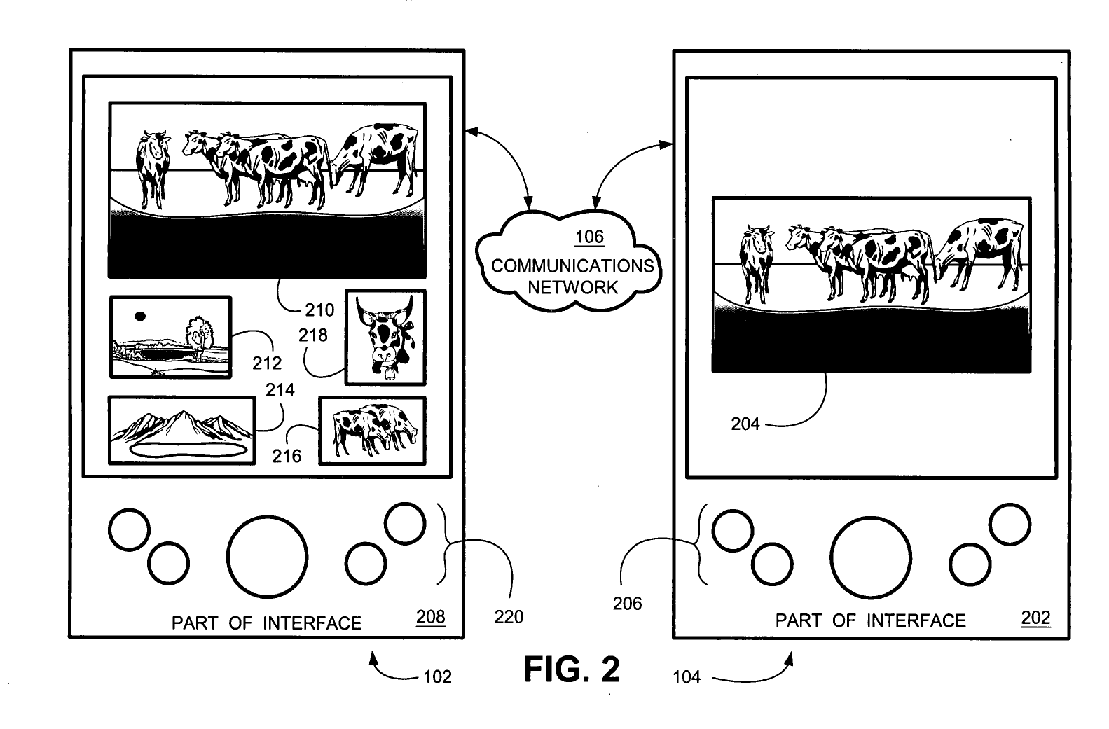

FIG. 2 illustrates, schematically, part 202 of the user interface 112′ of the first computer systems 104 (FIG. 1). The part 202 illustrates a digital photograph 204 of cows standing near the shore of a lake. The user interface may optionally comprise a number of controls 206 for controlling the display, selection and transmission of the image 204.

FIG. 2 also shows a part 208 of the user interface 112 of the second computer system 102 that part 208 of the user interface 112 depicts a shared media, such as photograph 210, which was received from the first computer system 104 (an example of the media 126 of FIG. 1). The shared photograph 210 corresponds to the digital photograph 204 illustrated using the first user interface 112′. The part 208 of the user interface 112 also shows a number of digital photographs 212, 214, 216 and/or 218 retrieved from the media storage 124 by the media search engine 116 in response to receipt of the metadata 128 (associated with the media 126, FIG. 1). Since these digital photographs 212 to 218 have been categorised using key words such as “cows” and “lake,” the media search engine 116 has caused the media-rendering engine 114 to display them via the user interface 112. The second part 208 of the user interface 114 also has a control portion 220, which can be used to select one of the displayed digital photographs 212, 214, 216 and 218 for transmission to the first computer system 104 and, ultimately, display via the user interface 112′ of the first computer system 104. Additionally, the corresponding related metadata 130 associated with a related digital photograph selected from the displayed digital photographs 212, 214, 216 and 218 may also be transmitted to the first computer system 104 where it could be processed in a similar manner to retrieve potentially related media 118′, 120′, 124′ and/or 122′ held by the media storage 124′.

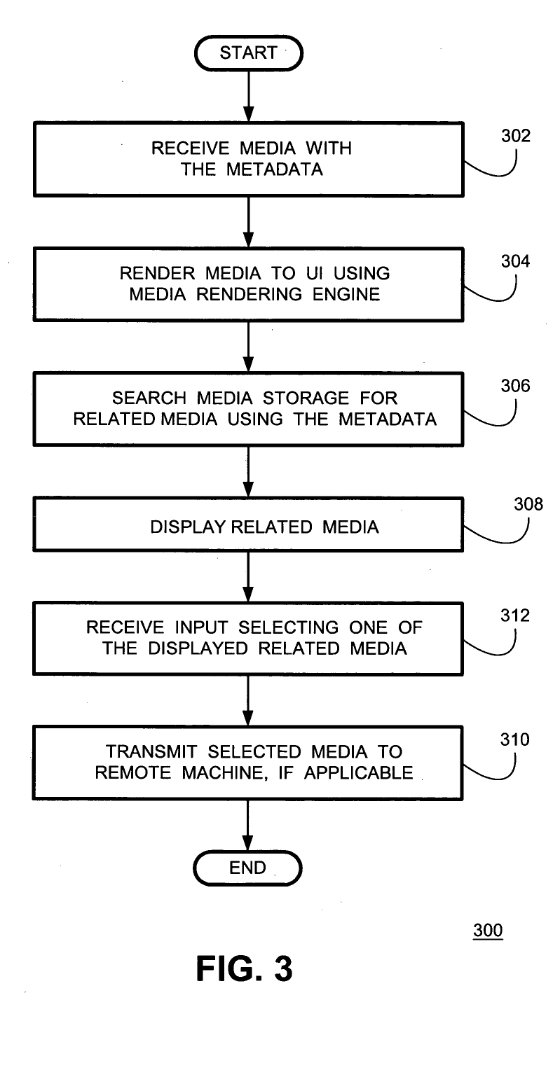

The operation of the computer systems 102 and 104 will be described with reference to FIG. 3. FIG. 3 shows a flow chart 300 of a process for context-based media retrieval for facilitating a communication exchange between users.

The media rendering engine 114 renders any received media 126 (FIG. 1) at step 304. Therefore the media 126 will be output in a perceivable form via the user interface 112 (and/or interface 112′). Substantially concurrently or sequentially with or to the output of the media 126, the media search engine 116, having been passed the metadata 128 by the controller 108, searches the media storage 124 for related media (118, 119, 120 or 122) held by that storage 124. In an exemplary embodiment, the search comprises seeking a match between the received metadata 128 and related metadata 130 associated with the related media (118, 119, 120 or 122) held on the media storage 124 at step 306. The related media (118, 119, 120 or 122) associated with any matching or related metadata 130 is displayed at step 308, via the media-rendering engine 114, on the user interface 112.

Although the above embodiment indicates that the related or matching media (118, 119, 120 and/or 122) are displayed on the user interface 112, it will appreciated that embodiments can be realised in which a saliency measure is used to rank the media and only selected media from all matching media are displayed according to that measure. The user (not shown), using the user interface 112, can select one of the displayed related media (118, 119, 120 or 122) at step 310.

Optionally, the user of the computer system 102 may indicate that they also have media that may be of interest to the user (not shown) of the computer system 104. If the latter user expresses an interest in the recently identified media, the computer system 102 may transmit the selected related media to the first computer system 104 where it can be displayed on the user interface 112′ using the media rendering engine 114′ at step 312.

It can be appreciated that the automatic search, retrieval and display of related media provides a prompt to the user (not shown) of the first computer system 104 which may cause that user to contribute to the conversation or to engage the user of the first computer system 104 thereby overcoming the traditional urge to remain silent as is often the case when one party is showing the second party, photographs, for example.

The user of the first computer system 104 may transmit selected media 126 from the first computer system 104. The media 126 may be accompanied by metadata 128 describing or related to the media 126. As described above, for example, the media 126 may be a digital photograph of cows standing by the shore of a lake and the metadata may comprise the set of words “cows” and “lake.” The media 126 and metadata 128 are received by the second computer system 102. The controller 108 causes the media rendering engine 114 to display or output a media via the user interface 112 and forwards the metadata 128 to the media search engine 116 where it is used to perform a search of the media 118, 119, 120 to 122 stored using the media storage 124. The search is performed to identify matching or related media that may be of interest to the first user (not shown).

Although the above embodiments have been described with reference to the use of metadata to identify potentially related media, embodiments of the present invention are not limited to such an arrangement. Embodiments can be realised in which the media to be shared is transmitted without the metadata and a sophisticated media search engine can be arranged using, for example, image processing techniques or pattern matching techniques, to identified related media.

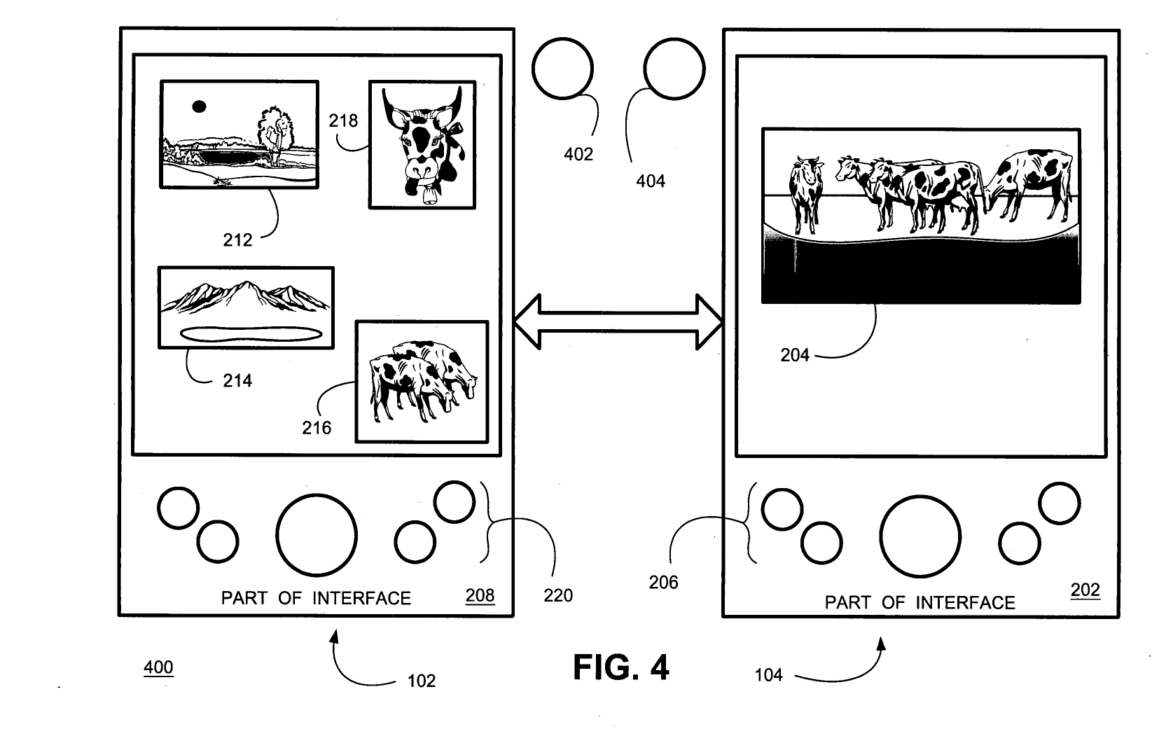

Referring to FIG. 4 there is illustrated an exchange 400 between user 402 and 404 of the computers 102 and 104, respectively, according to a second embodiment. In the second embodiment the computers 102 and 104 operate substantially as described above but for the exchange of media 126 (FIG. 1), which is absent in the second embodiment. The second embodiment does not exchange the media 126 itself. The second embodiment exchanges the metadata 128 of the currently displayed image. It can be seen that the portion 202 of the user interface 112′ of the first computer system 104 is substantially identical to that described above with reference to FIG. 2. It can be appreciated from FIG. 4 that the portion 208 of the user interface 112 of the first computer system 104 no longer contains the shared photograph 210 illustrated in FIG. 2; This portion 208 only displays related media 212, 214, 216 and/or 218 retrieved from the media storage 124 using the metadata 128 received from the first computer system 104. Using the second embodiment, the users 402 and 404 can engage in a conversation in which each user has their own, for example, digital photograph album from which context-sensitive photographs can be displayed and selected thereby facilitating a conversational exchange between the users 402 and 404.

The exchange of metadata 128 between the computers 102 and 104 can be realised using any convenient protocol.

In an embodiment the computers 102 and 104 store data identifying users from whose corresponding computers metadata can be accepted. In this manner, when the computer systems 102 and 104 are sufficiently close to each other, the first computer system 104 may merely transmit the metadata without it needing to be specifically addressed to the second computer system 102. The second computer system 102, under the influence of the controller 108 executing appropriate software, may receive the transmitted metadata and act upon it accordingly. However, before acting upon the metadata, the controller 108 of the second computer system 102 traverses its corresponding list of users from whose computer metadata can be accepted to identify a match. It will be appreciated in this embodiment that an indication of the addressor or sender of the metadata accompanies the metadata 128. This indication is used in the matching process. If it is determined that the identifier of the sender is contained within the list of users from whom the second computer system 102 is authorised to receive the metadata, the controller 108 causes the media search engine 116 to instigate a search for related media. The result of the search may be the display of digital photographs such as, for example, digital photographs 212, 214, 216 and/or 218. The user 404 of the second computer system 102 may then, using the control section 220, select one of the digital photographs 212, 214, 216 and/or 218 which might then be displayed in an enlarged rather than thumbnail form to allow the user 404 to show the enlarged photograph (not shown) to the other user 402. Again, using the second embodiment, an exchange or conversation between the users 402 and 404 is facilitated using the context sensitive metadata to retrieve context-sensitive media.

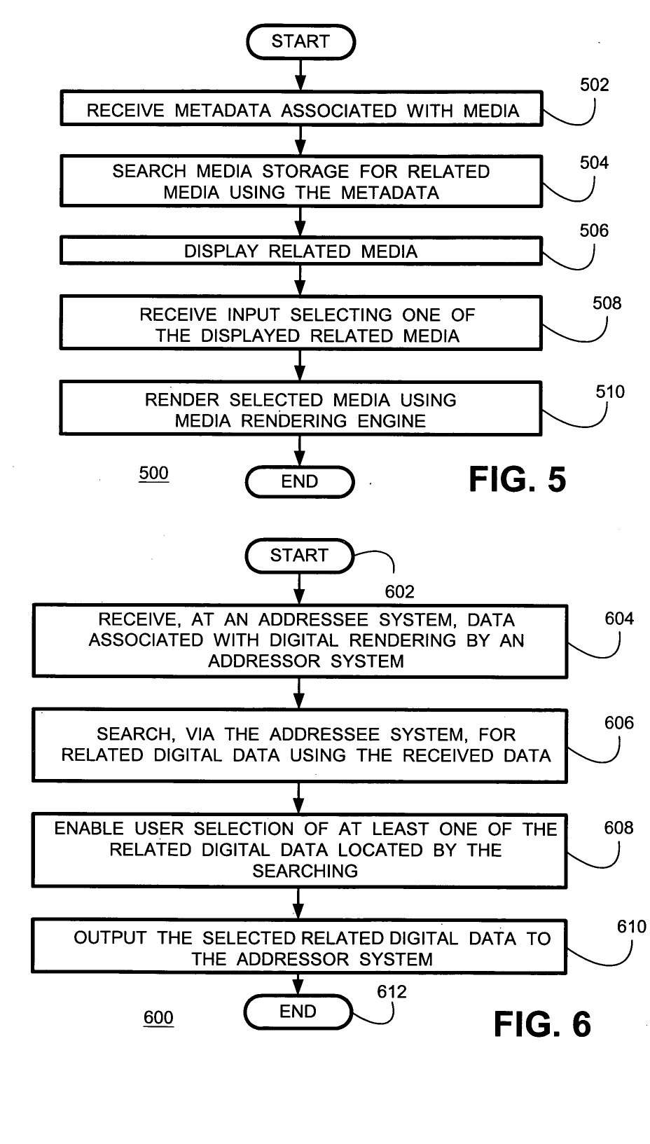

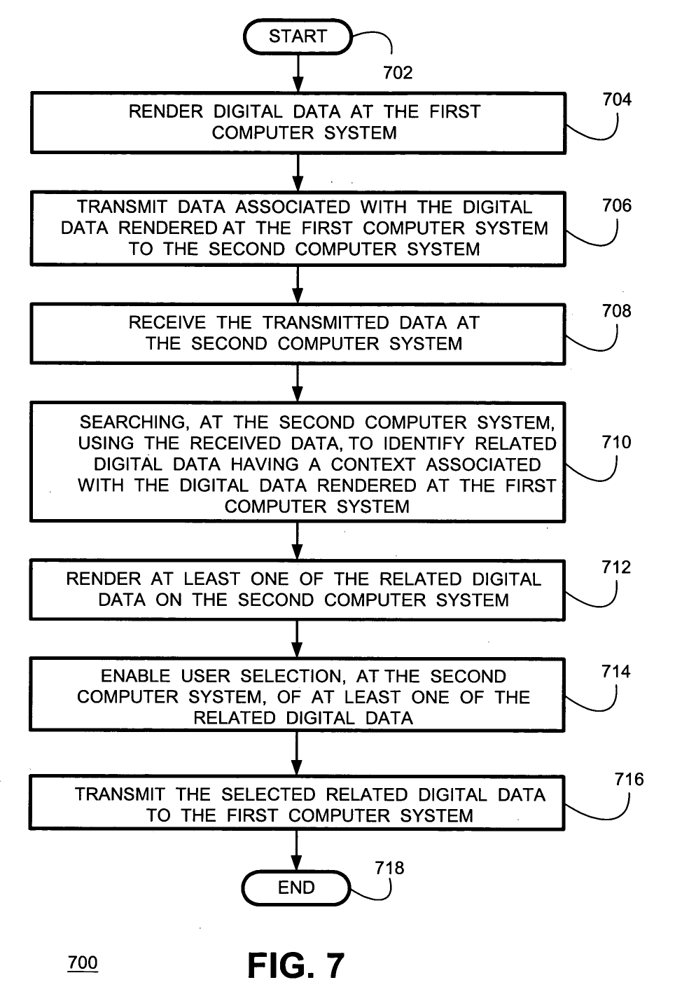

Referring to FIG. 5 there is shown a flowchart 500 of a process performed by the computer systems according to the second embodiment. At step 502, the second computer system 102 receives the metadata 128 transmitted by the first computer system 104 (FIG. 7). At step 506, the controller 108 causes the media search engine 116 to search the media 118, 119, 120 and/or 122 held by the media storage 124 for related media, that is, context-sensitive media. Any such related media is displayed on the display portion 208 of the user interface 112 at step 506. One of the displayed media is selected using the control portion 220 of the portion 208 (FIG. 2) of the user interface 112 at step 508. The selected media is displayed in enlarged form at step 510 for presentation to a friend or colleague.

FIG. 6 depicts a flow chart 600 of a process performed by another embodiment of the present invention. The flow chart 600 shows the architecture, functionality, and operation of a possible implementation of the software for implementing the logic of the media search engine 116, 116′ (FIG. 1). In this regard, each block may represent a module, segment, or portion of code, which comprises one or more executable instructions for implementing the specified logical function(s). It should also be noted that in some alternative implementations, the functions noted in the blocks may occur out of the order noted in FIG. 6 or may include additional functions without departing significantly from the functionality of the process of FIG. 6. For example, two blocks shown in succession in FIG. 6 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process of flow chart 600 starts at block 602. At block 604, at an addressee system, data is received that is associated with digital data rendered by an addressor system. At block 606, via the addressee system, related digital data using the received data is searched for. At block 608, enabling user selection of at least one of the related digital data located by the searching is enabled. At block 610, the selected related digital data to the addressor system is output. The process ends at block 612.

FIG. 7 depicts a flow chart 700 of a process performed by yet another embodiment of the present invention. The flow chart 700 shows the architecture, functionality, and operation of a possible implementation of the software for implementing the logic of the media search engine 116, 116′ (FIG. 1). In this regard, each block may represent a module, segment, or portion of code, which comprises one or more executable instructions for implementing the specified logical function(s). It should also be noted that in some alternative implementations, the functions noted in the blocks may occur out of the order noted in FIG. 7 or may include additional functions without departing significantly from the functionality of the process of FIG. 7. For example, two blocks shown in succession in FIG. 7 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process of flow chart 700 starts at block 702. At block 704, digital data at the first computer system is rendered. At block 706, data associated with the digital data rendered at the first computer system is transmitted to the second computer system. At block 708, the transmitted data is received at the second computer system. At block 710, using the received data, the second computer system is searched to identify related digital data having a context associated with the digital data rendered at the first computer system. At block 712, at least one of the related digital data on the second computer system is rendered. At block 714, user selection is enabled, at the second computer system, of at least one of the related digital data. At block 716, the selected related digital data is transmitted to the first computer system. The process ends at block 718.

Although the above embodiments have been described with reference to the second computer system 102 performing a search for related media, embodiments are not limited to such an arrangement. Embodiments can be realised in which the second computer system 102 merely instigates the search for such media, that is, the second computer system 102 may instruct a further computer system to perform the search rather than performing the search itself. It will be appreciated that such embodiments might at least reduce, and, preferably, remove the need to provide a complex local search engine.

Other embodiments provide a method further comprising searching, at the addressor computer system, for digital data using the copy of the selected digital data as a search key.

Other embodiments provide a method wherein the data associated with the selected digital data comprises a copy of metadata associated with the selected digital data and the method further comprises searching, using the copy of the metadata, to identify digital data having a context associated with the selected digital data.

Accordingly, some embodiments provide a data processing system comprising a digital data search engine arranged to perform a context-sensitive search of searchable digital data, stored using digital data storage, in response to data received from a first computer, to identify digital data having a substantially similar context to that of digital data associated with the first computer; the received data conveying the context of the digital data associated with the first computer, and means to output data associated with the identified digital data.

Other embodiments provide a data processing system in which the data received from the first computer comprises metadata associated with the digital data associated with the first computer. The metadata might comprise at least one keyword associated with the digital data associated with the first computer. The search engine may use the metadata to locate potentially interesting media.

Depending upon the complexity and sophistication of the media search engine, an alternative embodiment provides a data processing system in which the received data comprises a copy of the digital data associated with the first computer and the data processing system comprises a media rendering engine to render the copy of the first media. The search engine may use the copy of the digital data itself as the key for performing the search. For example, image or pattern recognition may be employed to locate potentially related media.

Other embodiments provide a data processing system wherein the communication mechanisms 110 and/or 110′ comprise a transmitter operable to send identified digital data to the computers. Furthermore, embodiments may provide a data processing system comprising a receiver operable to receive the data or media associated with the first computer.

Alternative embodiments provide a data processing system as described in any preceding embodiment in which the related digital data have associated metadata having at least one metadata item in common.

Some embodiments provide a data processing in which the digital data comprises at least one of audio data and visual data or at least data from which such audio and visual data can be derived. Accordingly, the digital data comprises digitally produced image data.

It will be appreciated that the searchable media may be stored locally or may be stored remotely, via, for example, a network drive or a server forming part of the Internet, that is, remotely stored media is stored using storage that is not directly accessible by or not integral to the data processing system. Suitably, embodiments provide a data processing system in which the media search engine comprises a means to access a remote storage device on which the searchable digital data is held.

Further embodiments provide a method of operating an addressee computer system comprising receiving data associated with digital data accessible to an addressor computer system; searching, at or via the addressee computer system, a plurality of digital data, using the received data, to identify at least one digital data of the plurality of digital data having a substantially similar or related context to the digital data of the addressor computer system.

Other embodiments provide a method further comprising the step of rendering the at least one digital data at the addressee computer system.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination.

Each feature disclosed in this specification (including any accompanying claims, abstract and drawings) may be replaced by alternative features serving the same, equivalent or similar purpose. Thus each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A method for sharing digital data, comprising:
receiving, at an addressee system, data associated with digital data rendered by an addressor system;
searching, via the addressee system, for related digital data using the received data;
enabling user selection of other digital data from any related digital data located by the searching; and
outputting the selected other digital data to the addressor system.

2. The method of claim 1, wherein the data associated with the selected other digital data comprises a copy of the selected other digital data and wherein the method further comprises rendering the copy of the selected other digital data at the addressor system.

3. The method of claim 2, further comprising searching, at the addressor system, for the digital data using the copy of the selected other digital data as a search key.

4. The method of claim 1, wherein the data associated with the selected other digital data comprises a copy of metadata associated with the selected digital data and the method further comprises searching, using the copy of the metadata, to identify the digital data having a context associated with the selected digital data.

5. The method of claim 1, further comprising the step of ranking any related digital data located by the searching prior to performing the selecting.

6. The method of claim 1, wherein the identified related digital data comprises related metadata associated with the identified related digital data, and the outputting the related digital data further comprises outputting the related metadata to the addressor system, such that the addressor system searches, using the related metadata, to identify additional digital data having a context associated with the related digital data.

7. A data processing system comprising:
a digital data search engine to perform a context-sensitive search of searchable digital data received from a first computer, arranged to identify other digital data having a substantially similar context to that of the received searchable digital data that conveys context of the received searchable digital data; and
a communication mechanism to output data associated with the identified other digital data to the first computer.

8. The data processing system of claim 7, in which the received searchable digital data comprises metadata associated with at least one characteristic of the received searchable digital data.

9. The data processing system of claim 8, in which the metadata comprises at least one keyword associated with the received searchable digital data.

10. The data processing system of claim 7, in which the received searchable digital data comprises a copy of received digital data associated with the first computer, and further comprising a media rendering engine to render the copy of the received digital data.

11. The data processing system of claim 7, further comprising a transmitter operable to send the identified other digital data to the first computer.

12. The data processing system of claim 7, in which the identified other digital data have associated related metadata, the related metadata having at least one metadata item in common with the received metadata.

13. The data processing system claim 7, in which the other digital data comprises at least one of audio data and visual data.

14. The data processing system of claims 7, further comprising a remote storage device on which the searchable digital data is held, wherein the remote storage device is accessible by the processing system.

15. The data processing system of claim 7, wherein the identified other digital data comprises a copy of at least one other digital data to transmit the copy to the first computer.

16. The data processing system of claim 15, further comprising a second digital data search engine, at the first computer, to search for additional digital data using the copy of the other digital data as a search key.

17. The data processing system of claim 7, wherein the identified other digital data comprises other metadata associated with the identified other digital data, and the communication mechanism transmits a copy of the other metadata to the first computer, such that the first computer searches, using the other metadata, to identify additional related digital data having a context associated with the identified other digital data.

18. A method of sharing digital data between a first computer system and a second computer system comprising:
rendering digital data at the first computer system;
transmitting data associated with the digital data rendered at the first computer system to the second computer system;
receiving the transmitted data at the second computer system;
searching, at the second computer system, using the received data, to identify other digital data having a context associated with the digital data rendered at the first computer system;
rendering at least one of the other digital data on the second computer system;
enabling user selection, at the second computer system, of at least one of the other rendered digital data; and
transmitting the selected other digital data associated to the first computer system.

19. The method of claim 18, further comprising rendering the received other digital data at the first computer system.

20. The method of claim 18, further comprising searching, at the first computer system, for additional digital data using the received other digital data as a search key.

21. The method of claim 20, wherein the data transmitted to the second computer system comprises metadata, and wherein the searching at the second computer system comprises using the metadata to identify the other digital data having a context associated with the metadata of the digital data at the first computer system.

22. The method of claim 21, wherein the other digital data comprises other metadata, and wherein the searching at the first computer system comprises using the other metadata to identify the additional digital data having the context associated with the selected other digital data.

23. A system for sharing digital data between a first computer system and a second computer system comprising:
means for rendering digital data at the first computer system;
means for transmitting data associated with the digital data rendered at the first computer system to the second computer system;
means for receiving the transmitted data at the second computer system;
means for searching, at the second computer system, using the received data, to identify other digital data having a context associated with the digital data rendered at the first computer system;
means for rendering at least one of the other digital data on the second computer system;
means for enabling user selection, at the second computer system, of the at least one of the other rendered digital data;
means for transmitting the selected other digital data associated to the first computer system; and
means for rendering, at the first computer system, the transmitted other digital data.

24. The system of claim 23, further comprising a second means for searching, at the first computer system, for additional digital data using the received other digital data as a search key.

25. The system of claim 24, wherein the data transmitted to the second computer system comprises metadata, and wherein the means for searching at the second computer system comprises using the metadata to identify the other digital data having a context associated with the metadata of the digital data at the first computer system.

26. The system of claim 25, wherein the other digital data comprises other metadata, and wherein the searching at the first computer system comprises using the other metadata to identify the additional digital data having the context associated with the selected other digital data.

27. A program for sharing digital data stored on a computer-readable medium, the program comprising logic configured to perform:
receiving, at an addressee system, data associated with digital data rendered by an addressor system;
searching, via the addressee system, for related digital data using the received data;
enabling user selection of other digital data from any related digital data located by the searching; and
outputting the selected other digital data to the addressor system.
